(19) United States
(12) Patent Application Publication
(10) Pub. No.: US 2018/0147901 A1
(43) Pub. Date: May 31, 2018

(54) WINCH MOUNTING APPARATUS

(71) Applicant: JAGUAR LAND ROVER LIMITED, Whitley, Coventry, Warwickshire (GB)

(72) Inventor: William CRAMP, Coventry, Warwickshire (GB)

(21) Appl. No.: 15/570,529

(22) PCT Filed: Apr. 26, 2016
(86) PCT No.: PCT/EP2016/059289

§ 371 Date: Oct. 30, 2017

(30) Foreign Application Priority Data
Apr. 30, 2015 (GB) 1507367.9

(51) Int. Cl. B60D 1/56; B66D 1/36; B60R 19/48; B60R 19/34

(52) U.S. Cl. CPC B60D 1/56; B66D 1/36; B60R 2021/0074; B60R 19/34; B60R 19/48

(57) ABSTRACT

The present disclosure relates to a winch mounting assembly (1) for mounting a winch (2) to a vehicle (3). The winch mounting assembly (1) includes at least one mounting bracket (7-1, 7-2) for mounting to a vehicle chassis member (4); and a winch cradle (6) for supporting the winch (2). At least one crush can device (8-1, 8-2) is disposed between the at least one mounting bracket (7-1, 7-2) and the winch cradle (6). The present disclosure also relates to a vehicle (3); and to a method of mounting a winch mounting assembly (1).

### TECHNICAL FIELD

The present disclosure relates to a winch mounting apparatus. More particularly, but not exclusively, the present disclosure relates to a winch mounting apparatus for mounting a winch to a vehicle.

### BACKGROUND

It is known to mount a winch to the front of a vehicle to provide a winching capability, for example to enable self-recovery of the vehicle, to assist recovery of another vehicle or to pull a load. The winch can, for example, be mounted to a vehicle intended for use off-road, such as a 4x4 vehicle, a utility vehicle or a sports utility vehicle (SUV). In view of the loads applied, the winch must be mounted to a sturdy structure positioned at the front of the vehicle. However, this is in the region of the vehicle that is usually used to absorb energy during the event of a frontal collision in modern vehicles, and so mounting a winch in this manner may result in a compromise between winching capability and energy absorption performance due to these opposing requirements.

It is known to provide a winch mounting assembly comprising a winch cradle in front of the vehicle bumper beam. A limitation of these types of winch mounting assemblies is that the winch cradle is typically only supported in a single plane and, therefore, fixings need to provide a sufficient clamping force to prevent the winch cradle from rotating relative to the vehicle in use, for example due to vibrations. To provide adequate clamping force, the fixings may be unintentionally over-tightened with the result that rearward movement of the winch mounting assembly may be impeded which can affect deformation of the crash structure in the event of a collision.

At least in certain embodiments, the present invention seeks to provide a secure winch mounting assembly for fixedly mounting a winch to a vehicle. Furthermore, at least in certain embodiments, the winch mounting assembly is arranged to work in conjunction with the vehicle crash structure to absorb energy in the event of a collision.

### SUMMARY OF THE INVENTION

Aspects of the present invention relate to a winch mounting apparatus; and to a vehicle having a winch mounting apparatus. Aspects of the present invention also relate to a method of installing a winch mounting apparatus to a vehicle.

According to a further aspect of the present invention there is provided a winch mounting assembly for mounting a winch to a vehicle, the winch mounting assembly comprising:
at least one mounting bracket for mounting to a vehicle chassis member;
a winch cradle for supporting the winch;
at least one crush can device disposed between the at least one mounting bracket and the winch cradle. The at least one crush can device provides an energy absorbing sub-structure which can deform progressively and under steady load. In the event of a frontal collision coincident with the winch mounting assembly, the at least one crush can device is suitable for absorbing energy from the collision. Thus, at least in certain embodiments, the winch mounting assembly can operate in conjunction with the vehicle crash structure to manage the transmittal of loads into the vehicle.

The winch mounting assembly can be mounted to the vehicle in place of, or supplementary to a vehicle bumper beam. To ensure the system can manage the recovery/winching loads, the winch mounting assembly is configured to prevent movement during winching whist permitting rearward movement in the event of a frontal collision.

The winch mounting assembly can comprise one or more sliding joint. For example, the winch mounting assembly can comprise first and second sliding joints disposed on respective first and second sides of the winch cradle. The winch mounting assembly can comprise a plurality of mounting brackets. The mounting brackets can cooperate with the winch cradle to form a plurality of sliding joints. The winch mounting assembly can comprise a plurality of crush can devices. One or more of said sliding joints can be associated with each crush can device. For example, a first sliding joint can be associated with a first crush can device; and a second sliding joint can be associated with a second crush can device.

The crush can device and the sliding joint can be disposed alongside each other. The crush can device may define a central longitudinal axis which in certain embodiments is arranged at least substantially parallel to a sliding axis of the sliding joint. One or more crush can device can be associated with each sliding joint.

Each mounting bracket can comprise at least one guide member. The winch cradle can comprise at least one sliding bracket for cooperating with said at least one guide member to form the at least one sliding joint. The at least one guide member and the at least one sliding bracket can have matching profiles. This arrangement can inhibit movement of the sliding joint in one or more direction, for example in a transverse direction and/or a vertical direction.

The mounting bracket can comprise first and second guide members, and the sliding bracket comprises first and second sliding members. The first and second guide members and the first and second sliding members can cooperate to inhibit movement of the sliding joint in first and second directions. The first and second guide members can be arranged substantially perpendicular to each other to form an L-shaped profile. Similarly, the first and second sliding members can be arranged substantially perpendicular to each other to form an L-shaped profile. This arrangement can secure the winch cradle in the horizontal and vertical planes and constrain movement in a longitudinal direction.

The first and second guide members can each comprise first and second elongated slots. The first and second sliding members can each comprise third and fourth elongated slots. The first and second slots are operatively aligned with the third and fourth elongated slots. First and second sliding fasteners can be disposed in elongated slots to form first and second sliding joints. The first and second sliding fasteners can be disposed in said elongated slots such that the winch cradle is only able to move in a rearwards direction. By rearward direction it is meant, in a direction towards and substantially parallel to the longitudinal axis of the vehicle. For example, the first and second sliding fasteners can be disposed at a front of said first and second elongated slots; and at a rear of the third and fourth elongated slots.

The winch cradle can comprise at least one transfer member for engaging a distal end of the at least one crush can device. In the event of a frontal collision, the at least one transfer member is configured to transfer collision loads applied to the winch cradle into the at least one crush can device. A reinforcing member can be provided for reinforcing each transfer member. The reinforcing member can be inclined at an acute angle relative to the transfer member. The reinforcing member can, for example, extend from a distal end of the transfer member to a side wall of the winch cradle. The reinforcing member can help to reduce deformation of the at least one transfer member.

The at least one transfer member can comprise at least one section extending operatively towards the vehicle chassis member. For example, the at least one transfer member can comprise upper and lower flanges. The upper and lower flanges can extend towards a base portion of the mounting bracket. The at least one flange can be sized to limit displacement of the winch cradle in a rearwards direction. The at least one flange can, for example, be sized to engage the base portion of the mounting bracket when the crush can device has been crushed by a prescribed amount.

The at least one crush can device in certain embodiments may be fastened to the mounting bracket and/or to the winch cradle. Mechanical fasteners can be used to mount the at least one crush can device to the mounting bracket and/or to the winch cradle.

The winch cradle can comprise a front plate for positioning behind a front bumper or a front valance disposed on the vehicle. The front plate can be profiled to match the profile of the front bumper or the front valance or fascia.

A cable dispensing aperture can be formed in said front plate. The cable from the winch can be extended through said cable dispensing aperture. The front bumper can comprise a corresponding bumper aperture.

According to a still further aspect of the present invention there is provided a winch mounting assembly for mounting a winch to a vehicle, the winch mounting assembly comprising:
at least one mounting bracket for mounting to a vehicle chassis member; and
a winch cradle comprising at least one transfer member for cooperating with the at least one mounting bracket to form a sliding joint;
wherein each mounting bracket comprises first and second guide members; and each sliding bracket comprises first and second sliding members;
the first and second guide members being configured to cooperate with the first and second sliding members to inhibit movement of the sliding joint in at least first and second directions.

According to a yet further aspect of the present invention there is provided a winch mounting assembly as described herein in combination with a winch.

According to a still further aspect of the present invention there is provided a vehicle comprising a winch mounting assembly as described herein. The winch mounting assembly can be mounted to a vehicle chassis member, such as a front cross member. A front bumper can be disposed in front of said winch mounting assembly

According to a further aspect of the present invention there is provided a method of mounting a winch mounting assembly to a vehicle chassis, the method comprising: detaching a front bumper beam from the vehicle chassis; removing at least one crush can device from the vehicle chassis and installing said at least one crush can device in the winch mounting assembly; and mounting the winch mounting assembly to the vehicle chassis. The at least one crush can device can be installed in the winch mounting assembly before or after the winch mounting assembly is mounted to the vehicle chassis.

The term “crush can device” is used herein to refer to a sacrificial crash structure configured to deform in a controlled manner under loading. The crush can device can, for example, comprise a metal cylinder (which may be open or closed). Alternative terms for these crash structures include: an “absorber” and a “crash can device”. Other energy absorbing devices, such as foam, are also contemplated.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 shows a vehicle having a winch installed in accordance with an embodiment of the present invention;

FIG. 2 shows a perspective view of the winch mounting assembly and the winch in the arrangement shown in FIG. 1;

FIG. 3 shows a perspective view from above of a winch cradle forming part of the winch mounting assembly shown in FIG. 2;

FIG. 4 shows a perspective view from behind of the winch cradle shown in FIG. 3;

FIG. 5 shows a perspective side view of a mounting bracket forming part of the winch mounting assembly shown in FIG. 1;

FIG. 6 shows a perspective side view of the winch mounting assembly; and

FIG. 7 shows a perspective view from below of the winch mounting assembly.

### DETAILED DESCRIPTION

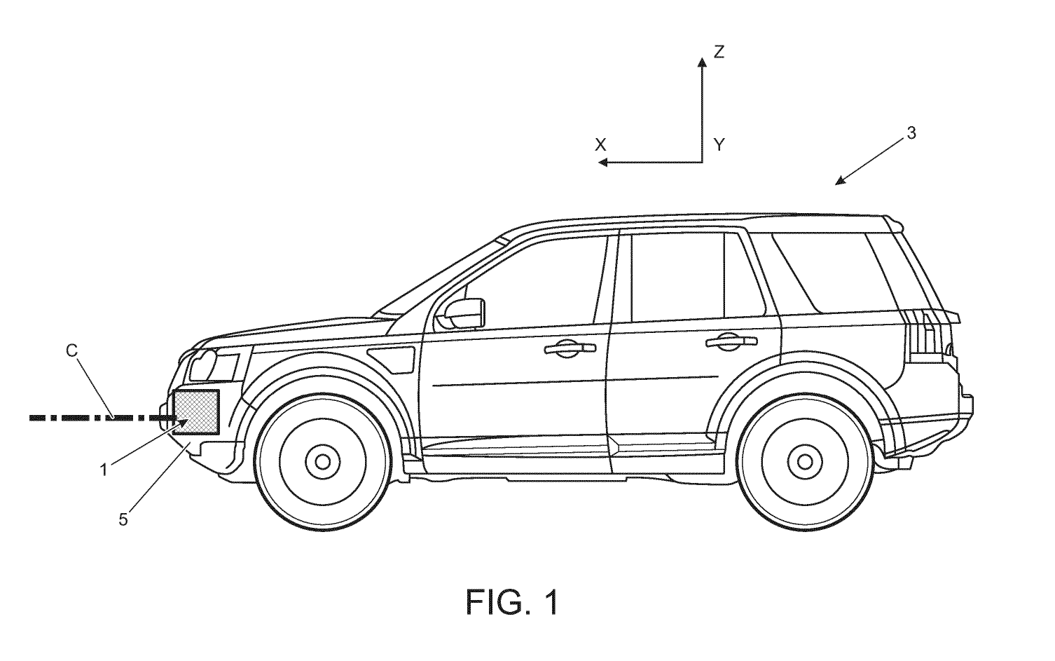

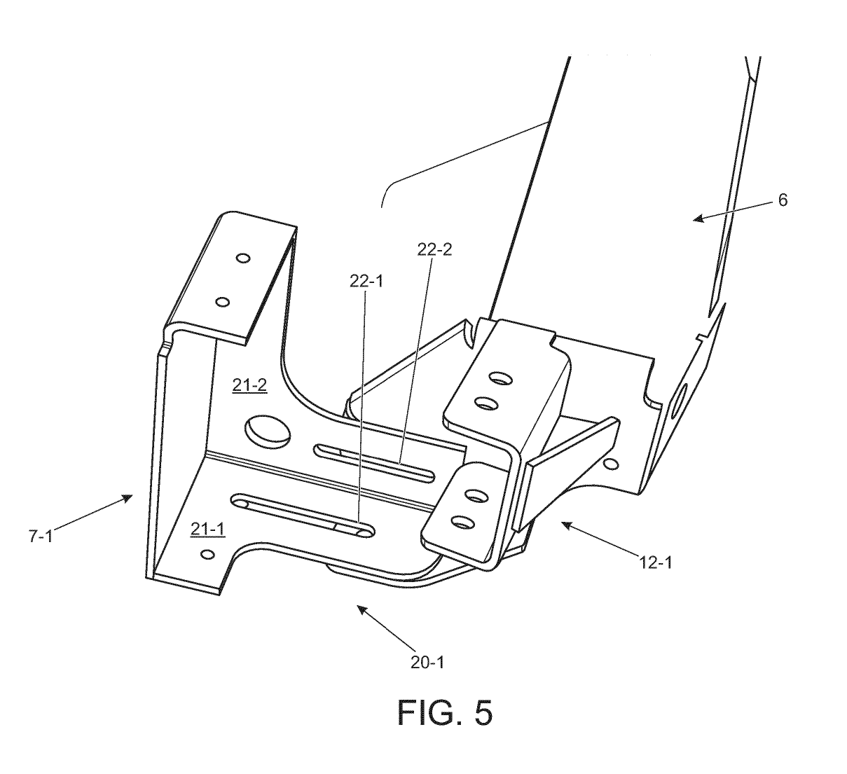

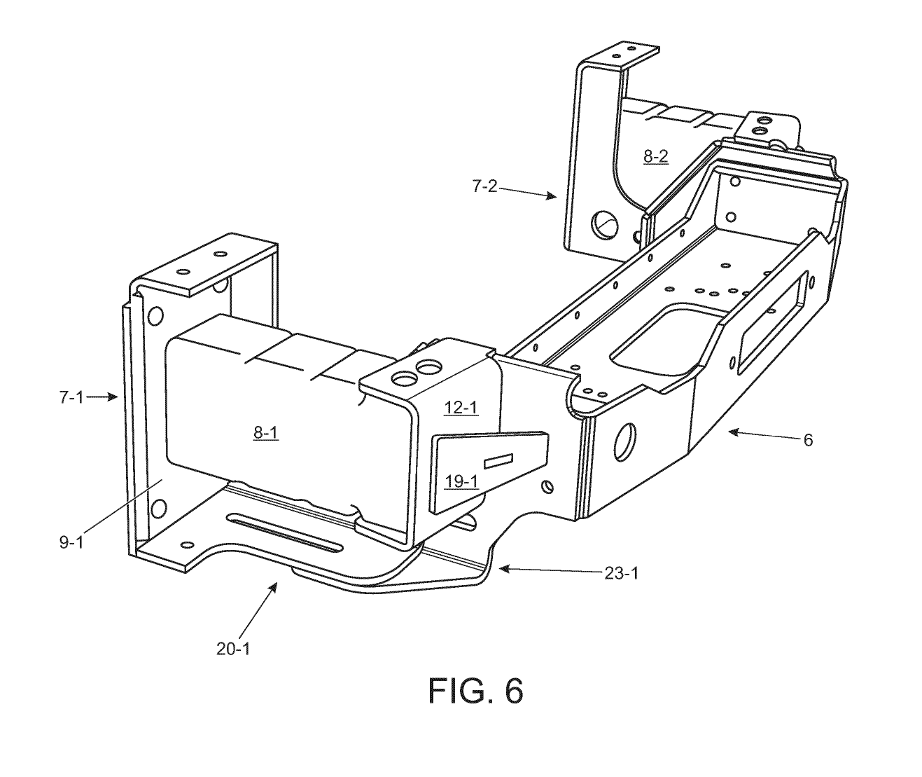

A winch mounting assembly 1 for mounting a recovery winch 2 to a vehicle chassis in accordance with an embodiment of the present invention will now be described with reference to FIGS. 1 to 7. As shown in FIG. 1, in the present embodiment the winch mounting assembly 1 is mounted to a vehicle 3. The winch mounting assembly 1 will be described with reference to a longitudinal axis X, a transverse axis Y and a vertical axis Z of the vehicle 3.

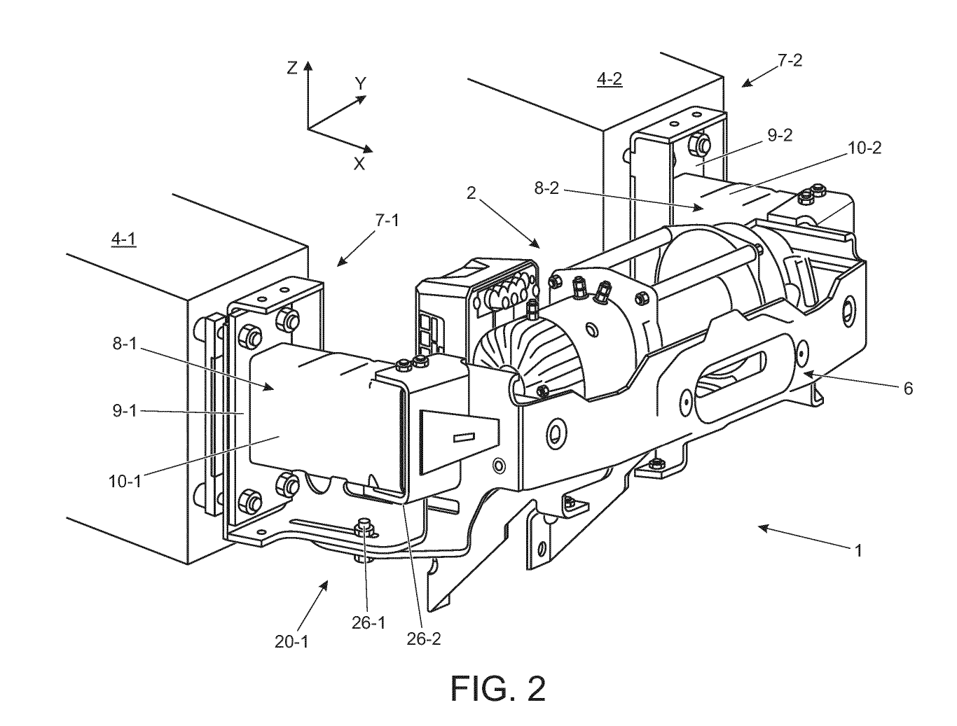

The winch mounting assembly 1 is mounted to first and second longitudinal chassis members 4-1, 4-2 (shown in phantom in FIG. 2) disposed at the front of the vehicle chassis to support a front bumper 5. The recovery winch 2 comprises an electric motor drivingly connected to a horizontal winch drum onto which a winch cable is wound. In the present embodiment, the winch mounting assembly 1 is disposed behind the front bumper 5 of the vehicle 3. Furthermore, the winch mounting assembly 1 is adapted to mount the recovery winch 2 within the front bumper 5 such that the winch cable C (shown schematically in FIG. 1 by a dashed line) extends through a bumper aperture, as shown in FIG. 1. The recovery winch 2 is operable to generate a pulling force, for example to enable the vehicle 3 to self-recover. In alternate arrangements, the recovery winch 2 could, for example, comprise a mechanical actuator or a hydraulic motor for drivingly rotating the winch drum.

As shown in FIG. 2, the winch mounting assembly 1 comprises a winch cradle 6; first and second mounting brackets 7-1, 7-2; and first and second crush can devices 8-1, 8-2. The first and second mounting brackets 7-1, 7-2 are adapted to be fixedly mounted to the first and second longitudinal chassis members 4-1, 4-2. The first and second crush can devices 8-1, 8-2 are of conventional design and comprise respective first and second back plates 9-1, 9-2 and first and second tubular members 10-1, 10-2 having a closed section. The first and second crush can devices 8-1, 8-2 are fixedly mounted to the first and second mounting brackets 7-1, 7-2 by a plurality of mechanical fasteners. The first and second crush can devices 8-1, 8-2 form part of the vehicle crash structure and, in the event of a frontal collision, are configured to collapse progressively and to sustain a steady load. The first and second crush can devices 8-1, 8-2 are operative to absorb energy in the event of a frontal collision rather than transfer it directly into the vehicle chassis. At least in certain arrangements, the first and second crush can devices 8-1, 8-2 can collapse progressively until their length is reduced to approximately 25% of their original length. The first and second crush can devices 8-1, 8-2 are configured such that their load-bearing characteristics are mechanically calibrated in accordance with other vehicle systems, for example the supplemental restraint system (SRS) control for deploying (or not deploying) supplemental restraints in a vehicle such as an airbag or a seatbelt pre-tensioner.

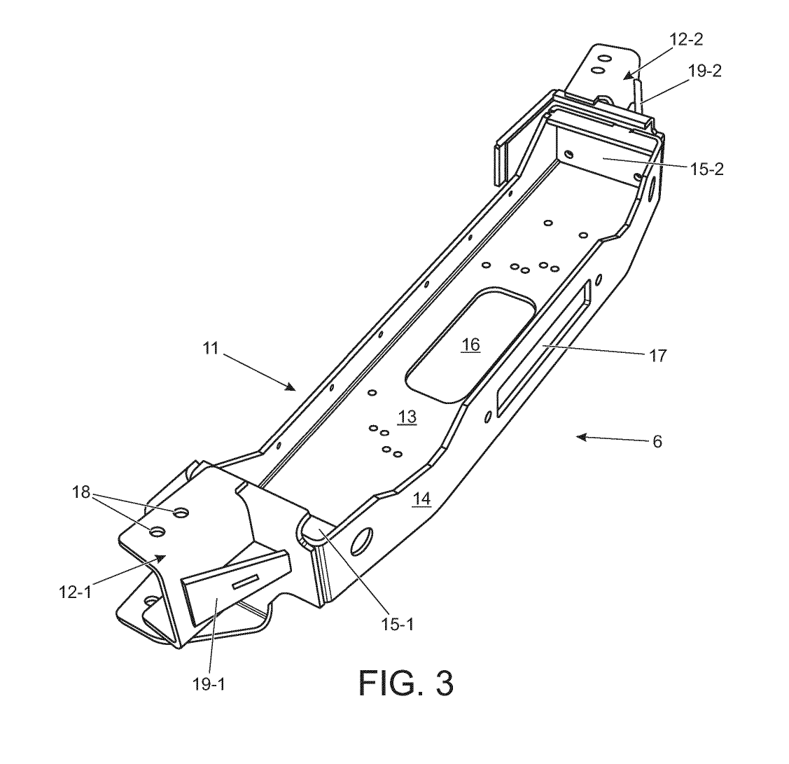

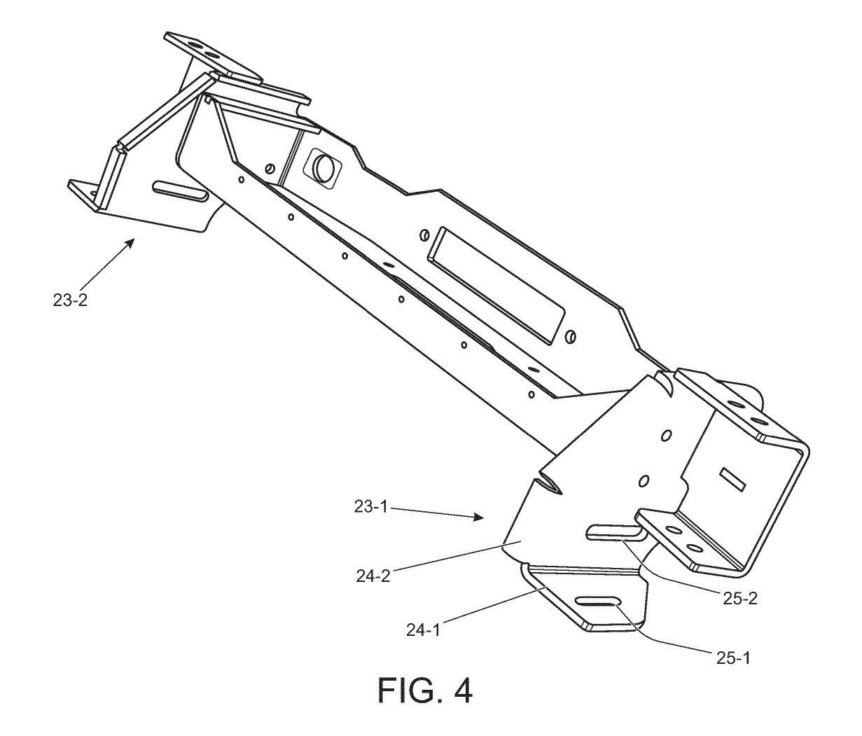

The winch cradle 6 comprises a tray 11 and first and second transfer members 12-1, 12-2, as shown in FIGS. 3 and 4. The tray 11 defines a mounting substructure for the recovery winch 2. In particular, the tray 11 defines a base plate 13 to which the recovery winch 2 is fixedly mounted; a front plate 14; and first and second end plates 15-1, 15-2. In an alternative arrangement, the recovery winch 2 could be mounted to the front plate 14 of the tray 11. The front plate 14 in the present embodiment has a curved profile at least substantially to match the profile of the front bumper 5. A base plate aperture 16 is formed centrally in the base plate 13 to control deformation of the winch cradle 6 upon application of a collision load to the centre of front plate 14. A cable dispensing aperture 17 is formed in the front plate 14 for alignment with the bumper aperture to dispense cable (not shown) from the recovery winch 2. The first and second transfer members 12-1, 12-2 are fixedly mounted to the first and second end plates 15-1, 15-2 respectively. The first and second transfer members 12-1, 12-2 extend transversely from each side of the tray 11 to engage the first and second crush can devices 8-1, 8-2. Each of the first and second transfer members 12-1, 12-2 has a C-shaped profile for receiving a front end of the respective first and second crush can devices 8-1, 8-2. The upper and lower flanges of the first and second transfer members 12-1, 12-2 extend in a rearwards direction and have a length which is substantially equal to (or shorter than) a predetermined fully collapsed length of the first and second crush can devices 8-1, 8-2. Thus, once the first and second crush can devices 8-1, 8-2 have been crushed, the rearmost ends of the first and second transfer members 12-1, 12-2 may contact the first and second back plates 9-1, 9-2 of the mounting brackets 7-1, 7-2. In the present embodiment, the first and second transfer members 12-1, 12-2 have a plurality of fastening apertures 18 for receiving mechanical fasteners to fasten the first and second transfer members 12-1, 12-2 to the first and second crush can devices 8-1, 8-2. First and second reinforcing members 19-1, 19-2 extend from the first and second end plates 15-1, 15-2 to reinforce the first and second transfer members 12-1, 12-2. The first and second reinforcing members 19-1, 19-2 are inclined at an acute angle relative to the first and second transfer members 12-1, 12-2 to form a triangular reinforcing structure. It will be appreciated that the first and second reinforcing members 19-1, 19-2 could be omitted, for example by using a thicker gauge material to form the first and second transfer members 12-1, 12-2 to resist buckling.

As shown in FIGS. 4, 5, 6 and 7, the winch mounting assembly 1 comprises first and second sliding joints 20-1, 20-2 for permitting longitudinal movement of the winch cradle 6 under load. The first and second sliding joints 20-1, 20-2 are arranged to inhibit longitudinal movement of the winch cradle 6 below a predetermined applied load, referred to as the “slip load”. The first and second mounting brackets 7-1, 7-2 each comprise first and second guide members 21-1, 21-2 which are fixedly mounted to the vehicle chassis. The first guide members 21-1 are disposed substantially horizontally; and the second guide members 21-2 are disposed substantially vertically. The first and second guide members 21-1, 21-2 each have first and second elongated apertures 22-1, 22-2 formed therein. The winch cradle 6 comprises first and second sliding brackets 23-1, 23-2 for cooperating with the first and second mounting brackets 7-1, 7-2. The first and second sliding brackets 23-1, 23-2 each comprise first and second sliding members 24-1, 24-2 having third and fourth elongated apertures 25-1, 25-2 formed therein, as shown in FIG. 4. The first sliding members 24-1 are disposed substantially horizontally; and the second sliding members 24-2 are disposed substantially vertically. The first guide member 21-1 and the first sliding member 24-1 are disposed alongside each other in a face-to-face arrangement to inhibit movement of the winch cradle 6 in a vertical direction. The second guide member 21-2 and the second sliding member 24-2 are disposed alongside each other in a face-to-face arrangement to inhibit movement of the winch cradle 6 in a transverse direction. The first and second guide members 21-1, 21-2, and the first and second sliding members 24-1, 24-2 are arranged substantially parallel to the longitudinal axis X of the vehicle 3. Similarly, the first, second, third and fourth elongated apertures 22-1, 22-2, 25-1, 25-2 each extend along respective central axes disposed parallel to said longitudinal axis X. As shown in FIG. 2, first and second sliding fasteners 26-1, 26-2 are disposed in said elongated apertures 22-1, 22-2, 25-1, 25-2 to clamp the first and second mounting brackets 7-1, 7-2 to the first and second sliding brackets 23-1, 23-2 respectively. In the present embodiment, the first and second sliding fasteners 26-1, 26-2 are M12 bolts (Grade 10.9) tightened by applying a torque of 55 Nm. The clamping force applied by the first and second sliding fasteners 26-1, 26-2 means that a longitudinal slip force of approximately 45 kN is required to displace the winch cradle 6 in a rearwards direction. The perpendicular arrangement of the first and second guide members 21-1, 21-2; and of the first and second sliding members 24-1, 24-2 means that the first and second sliding joints 20-1, 20-2 at least substantially inhibit movement of the winch cradle 6 in vertical and transverse directions. Thus, the winch cradle 6 is constrained to travel in a longitudinal direction parallel to the longitudinal axis X of the vehicle 3.

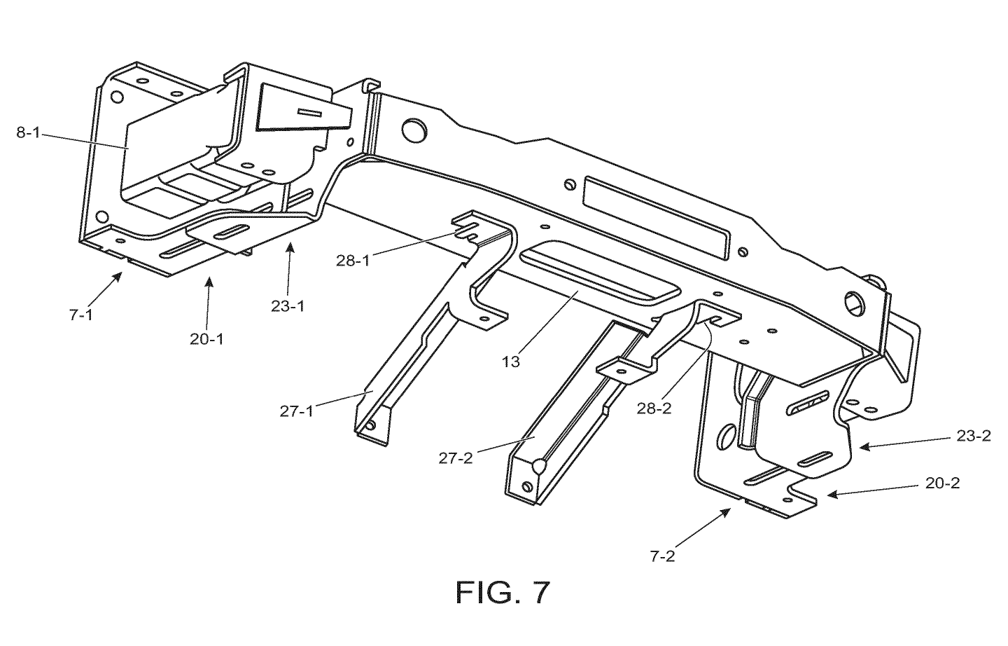

As shown most clearly in FIG. 7, the winch mounting assembly 1 comprises first and second support legs 27-1, 27-2 connected to an underside of the base plate 13 to support the winch cradle 6. The first and second support legs 27-1, 27-2 each have rearward facing slots 28-1, 28-2 to enable the first and second support legs 27-1, 27-2 to detach from the winch cradle 6 in the event of a frontal collision.

The retro-fitting of the winch mounting assembly 1 to the vehicle 3 will now be described. The front bumper is removed from the vehicle 3. The first and second crush can devices 8-1, 8-2 support a vehicle bumper beam (not shown) which is removed. The first and second crush can devices 8-1, 8-2 can then be removed from the first and second longitudinal chassis members 4-1, 4-2. The first and second sliding fasteners 26-1, 26-2 in the winch mounting assembly 1 are loosened to enable the first and second sliding joints 20-1, 20-2 to be extended. The first and second crush can devices 8-1, 8-2 are inserted between the first and second mounting brackets 7-1, 7-2 and the respective first and second transfer members 12-1, 12-2. The crush can devices 8-1, 8-2 are then mechanically fastened to the first and second mounting brackets 7-1, 7-2 and the first and second transfer members 12-1, 12-2. The first and second sliding joints 20-1, 20-2 are then tightened to a predetermined torque (55 Nm in the present case). The first and second mounting brackets 7-1, 7-2 are mechanically fastened to the first and second longitudinal chassis members 4-1, 4-2 to mount the winch support assembly 1. The winch 2 can then be mounted in the winch cradle 6. The front bumper 5 is then mounted to the vehicle 3 to cover the winch mounting assembly 1 and the winch 2. The front bumper 5 is mounted in juxtaposition with the front plate 14 of the winch cradle 6. The front bumper 5 is mounted such that the bumper aperture aligns with the cable dispensing aperture 17 formed in the front plate 14. The winch cable is fed through the cable dispensing aperture 17 ready for use. Rather than retro-fit the winch mounting assembly 1 to the vehicle 3, the winch mounting assembly 1 and the recovery winch 2 can be installed during assembly of the vehicle 3, for example on a vehicle production line, in place of the vehicle bumper beam.

In normal use, the winch mounting assembly 1 supports the recovery winch 2 at the front of the vehicle 3. The first and second sliding joints 20-1, 20-2 are adapted to inhibit transverse and vertical movement of the winch mounting assembly 1. In particular, the horizontal arrangement of the first guide member 21-1 and the first sliding member 24-1 inhibit vertical movement of the winch cradle 6; and the vertical arrangement of the second guide member 21-2 and the second sliding member 24-2 inhibit transverse movement of the winch cradle 6. The first and second support legs 27-1, 27-2 provide additional vertical support for the winch mounting assembly 1. This arrangement allows the winch mounting assembly 1 to be fixedly mounted to the vehicle chassis without over-tightening the first and second sliding fasteners 26-1, 26-2. Rather, the first and second sliding fasteners 26-1, 26-2 can be tightened to a predefined torque (55 Nm in the present case) which determines the slip force required to displace the winch cradle 6. The first and second crush can devices 8-1, 8-2 are supported between the first and second mounting brackets 7-1, 7-2 and the first and second transfer member 12-1, 12-2.

In the event of a frontal collision, the winch mounting assembly 1 is configured to absorb energy rather than transmit it directly into the vehicle chassis. The base plate aperture 16 enables controlled deformation of the base plate 13 to help balance the transmittal of loads to the first and second sliding joints 20-1, 20-2. The application of a force exceeding the slip force (as determined by the first and second sliding fasteners 26-1, 26-2) causes the winch cradle 6 to be displaced in a rearwards direction towards the vehicle, driven by the force applied. The first and second sliding joints 20-1, 20-2 constrain the winch cradle 6 to travel in a longitudinal direction. The first guide member 21-1 and the first sliding member 24-1 inhibit vertical movement of the winch cradle 6; and the second guide member 21-2 and the second sliding member 24-2 inhibit transverse movement of the winch cradle 6. The first and second transfer members 12-1, 12-2 thereby apply a longitudinal force to the first and second crush can devices 8-1, 8-2 which is substantially parallel to their central axes. The first and second crush can devices 8-1, 8-2 undergo controlled and progressive deformation to absorb energy from the collision. Once the first and second crush can devices 8-1, 8-2 have collapsed to approximately 25% of their original length, the first and second transfer members 12-1, 12-2 engage the first and second back plates 9-1, 9-2 and are operative to transfer force into the vehicle chassis. In the event of a frontal collision in which the loads are insufficient to fully collapse the first and second crush can devices 8-1, 8-2, the loads applied to the vehicle chassis are insufficient to result in deformation. It will be appreciated that the winch mounting assembly 1, the front bumper 5, and the first and second crush can devices 8-1, 8-2 can be replaced.

The SRS control is typically calibrated to deploy airbags and/or seatbelt pre-tensioners in the vehicle 3 in dependence on a detected acceleration profile being above a certain threshold, which is at least partially determined by the energy absorption properties of the first and second crush can devices 8-1, 8-2. By utilising first and second crush can devices 8-1, 8-2 having the same mechanical properties as those installed in the vehicle 3 as standard to support the front bumper 5 (i.e. when the winch mounting assembly 1 is not fitted), the operation of the supplemental restraint system control can be developed to include consideration of the winch mounting assembly 1, inside its deployment thresholds calibration. It will be appreciated that if the winch mounting assembly 1 is retro-fitted to the vehicle 3, the first and second crush can devices 8-1, 8-2 used to support the front bumper 5 can be incorporated into the winch mounting assembly 1.

The first and second transfer members 12-1, 12-2 are effective to transfer collision loads into the respective first and second crush can devices 8-1, 8-2. This can expedite decision making by the SRS control compared to prior art arrangements which introduce an indirect load path or which require that the winch mounting assembly is displaced before collision loads are transmitted to the SRS control. By connecting the first and second transfer members 12-1, 12-2 to the respective first and second crush can devices 8-1, 8-2, loads can be transmitted directly into the first and second crush can devices 8-1, 8-2. In the event of a frontal collision, a crash pulse can be transmitted through the first and second crush can devices 8-1, 8-2 to the SRS control at least substantially instantaneously. This can reduce the time taken by the SRS control to deploy one or more supplemental restraint, such as an airbag, a seatbelt pre-tensioner, etc. In an alternative arrangement, the first and second transfer members 12-1, 12-2 are not fastened to the first and second crush can devices 8-1, 8-2. Instead, the first and second transfer members 12-1, 12-2 are disposed in contact with the first and second crush can devices 8-1, 8-2.

It will be appreciated that the winch mounting assembly 1 described herein may be readily adapted for use on the rear structure of a vehicle, for example to facilitate recovery or towing of other vehicles. In this case, the energy absorption mechanisms described above for mitigating forces applied by the impact to the front of the vehicle will provide a similar benefit to the rear of the vehicle in a rear mounted application and similarly may provide advantageous reduction in vehicle repair costs if the vehicle sustains a rear impact.

It will be appreciated that various changes and modifications can be made to the winch mounting assembly 1 described herein without departing from the scope of the present application.

1. A winch mounting assembly for mounting a winch to a vehicle, the winch mounting assembly comprising:
at least one mounting bracket for mounting to a vehicle chassis member;
a winch cradle for supporting the winch;
at least one crush can device disposed between the at least one mounting bracket and the winch cradle.

2. A winch mounting assembly as claimed in claim 1, wherein each mounting bracket cooperates with the winch cradle to form a sliding joint.

3. A winch mounting assembly as claimed in claim 2, wherein each mounting bracket comprises at least one guide member; and the winch cradle comprises at least one sliding bracket for cooperating with said at least one guide member to form said sliding joint.

4. A winch mounting assembly as claimed in claim 3, wherein the at least one guide member and the at least one sliding bracket cooperate with each other to inhibit movement of the sliding joint in one or more directions.

5. A winch mounting assembly as claimed in claim 4, wherein the mounting bracket comprises first and second guide members, and the sliding bracket comprises first and second sliding members; the first and second guide members cooperating with the first and second sliding members to inhibit movement of the sliding joint in at least first and second directions.

6. A winch mounting assembly as claimed in claim 5, wherein the first and second guide members comprise first and second elongated slots, and the first and second sliding members comprise third and fourth elongated slots; wherein first and second sliding fasteners are disposed in elongated slots to form said sliding joints.

7. A winch mounting assembly as claimed in claim 1, wherein said winch cradle comprises at least one transfer member for engaging a distal end of said at least one crush can device.

8. A winch mounting assembly as claimed in claim 7 comprising at least one reinforcing member plate for reinforcing said at least one transfer member.

9. A winch mounting assembly as claimed in claim 7, wherein said at least one transfer member comprises at least one flange extending operatively towards said vehicle chassis member.

10. A winch mounting assembly as claimed in claim 1, wherein the at least one crush can device is fastened to the mounting bracket and/or to the winch cradle.

11. A winch mounting assembly as claimed in claim 1, wherein the winch cradle comprises a front plate for positioning behind a front bumper of the vehicle.

12. A winch mounting assembly for mounting a winch to a vehicle, the winch mounting assembly comprising:
at least one mounting bracket for mounting to a vehicle chassis member; and
a winch cradle comprising at least one transfer member for cooperating with the at least one mounting bracket to form a sliding joint;
wherein each mounting bracket comprises first and second guide members; and each sliding bracket comprises first and second sliding members;
the first and second guide members being configured to cooperate with the first and second sliding members to inhibit movement of the sliding joint in at least first and second directions.

13. A winch mounting assembly as claimed in claim 1 in combination with a winch.

14. A vehicle comprising a winch mounting assembly for mounting a winch to a vehicle, the winch mounting assembly comprising:
at least one mounting bracket for mounting to a vehicle chassis member;
a winch cradle for supporting the winch; and
at least one crush can device disposed between the at least one mounting bracket and the winch cradle.

15. A vehicle as claimed in claim 14, wherein a front bumper is disposed in front of said winch mounting assembly.

16. A method of mounting a winch mounting assembly to a vehicle chassis, the method comprising:
detaching a front bumper beam from the vehicle chassis;
removing at least one crush can device from the vehicle chassis and installing said at least one crush can device in the winch mounting assembly; and
mounting the winch mounting assembly to the vehicle chassis.

17-19. (canceled)
